(19) United States
(12) Patent Application Publication
(10) Pub. No.: US 2005/0110286 A1
(43) Pub. Date: May 26, 2005

(54) System and method of generating an optimally-repeated turbo code stream

(76) Inventor: Wu Rong Zhang, Beijing (CN)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/773,987

(22) Filed: Feb. 5, 2004

(30) Foreign Application Priority Data
Nov. 25, 2003 (CN) 200310115430.X

(51) Int. Cl. B60R 19/04

(52) U.S. Cl. 293/154

(57) ABSTRACT

An apparatus of generating an output code stream includes a first bit repeater to repeat an incoming code stream, a second bit repeater to repeat a first parity bit stream of the incoming code stream, and a third bit repeater to repeat a second parity bit stream of the incoming code stream. A multiplexer is coupled to the first, second, and third bit repeaters to combine the repeated incoming code stream, the repeated first parity bit stream, and the repeated second parity bit stream to generate the output code stream that is optimally-repeated from the incoming code stream and its parity bit streams. A method of generating an optimally-repeated output code stream from an incoming code and its parity bit streams is also described.

### BACKGROUND

1. Technical Field

The present invention pertains to error-correction encoding. More particularly, this invention relates to a system and a method of generating an optimally-repeated code stream from an information code stream and its parity bit streams.

2. Description of the Related Art

One type of parallel convolutional codes is typically referred to as Turbo Codes. Turbo Codes belong to a relatively new class of forward error control codes that offer significant coding gain for power limited communication channels. Turbo Codes typically accomplish reliable communication at relatively low Eb/No (i.e., Bit Energy to Noise Density) ratio. When signal power of a signal is fixed, higher Eb/No ratio means that the signal contains low noise while lower Eb/No value indicates high noise level. In an interference constraint cellular wireless communication system, lower Eb/No requirement results in higher system capacity.

Turbo Codes are typically generated using two or more recursive systematic convolutional (RSC) encoders operating on different orderings of the same information bits. FIG. 1 shows one such prior art Turbo Code encoder 10. As can be seen from FIG. 1, the encoder 10 includes RSC encoders 13 and 14. The RSC encoder 13 generates a first parity bit stream P₁ from the information bits S. The RSC encoder 14 is connected to an interleaver 15 to generate a second parity bit stream P₂ from the information bits S that are interleaved by the interleaver 15. The information bits S and the first and second parity bits P₁ and P₂ are then multiplexed together by the multiplexer 12 to form the output code stream. The code can then be sent to a decoder 20 via a communication channel 30.

In order to match the speed of the encoder 10 with that of the communication channel 30, some bits of the Turbo Code generated at the multiplexer 12 should be repeated to adjust the transmission speed of the output code stream from the encoder 10. This code repetition function is performed by a code repeater 11. However, this code repetition scheme bears disadvantages. One disadvantage is that the repeater 11 repeats both the information bits and parity bits indiscriminately. This means that the repetition is committed over the entire code bit stream regardless whether the bit to be repeated is an information bit or parity bit. This is also true regardless whether the repetition is an equally-spaced uniform repetition or according to some sophisticated repetition schemes. As is known, the weight distributions for parity bit stream and information bit stream are not necessarily the same and it is desirable to assign more energy to the bit stream that has greater contribution in error correction capabilities. The indiscriminate repetition typically decreases the BER (i.e., Bits Error Rate) performance of the repeated Turbo Code. BER measures the percentage of error bits from the total bits transmitted, and thus indicates the communication reliability.

Thus, there exists a need to provide a Turbo Code encoder that generates optimally-repeated Turbo Code stream to allow for maximized BER performance.

### SUMMARY

One feature of the present invention is to generate an optimally-repeated output code stream from an incoming code and its parity bit streams.

An apparatus of generating an output code stream includes a first bit repeater to repeat an incoming code stream, a second bit repeater to repeat a first parity bit stream of the incoming code stream, and a third bit repeater to repeat a second parity bit stream of the incoming code stream. A multiplexer is coupled to the first, second, and third bit repeaters to combine the repeated incoming code stream, the repeated first parity bit stream, and the repeated second parity bit stream to generate the output code stream that is optimally-repeated from the incoming code stream and its parity bit streams.

A method of generating an optimally-repeated output code stream from an incoming code includes the operation of repeating the incoming code, a first parity bit stream of the incoming code, and a second parity bit stream of the incoming code individually and separately from each other such that optimal performance is obtained when the repeated incoming code, the repeated first parity bit stream, and the repeated second parity bit stream are combined to generate the output code. Then the repeated incoming code, the repeated first parity bit stream, and the repeated second parity bit stream are combined to generate the output code stream.

### BRIEF DESCRIPTION OF THE DRAWINGS

FIG. 1 shows a prior art Turbo Code encoder with bits repetition.

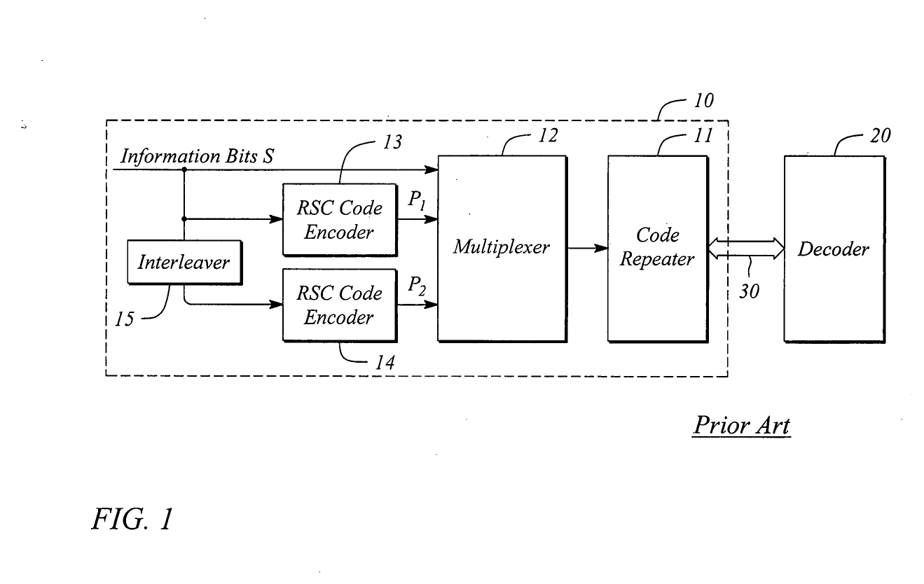

FIG. 2 schematically shows a Turbo Code encoder that implements one embodiment of the present invention.

FIG. 3 shows the BER performance against the percentage of repetition allocated to information bits within a Turbo Code bit stream, illustrating the optimum allocation of bit repetition between the information bits and parity bits.

FIG. 4 further shows the BER performance of the Turbo Code encoder of FIG. 2.

### DETAILED DESCRIPTION

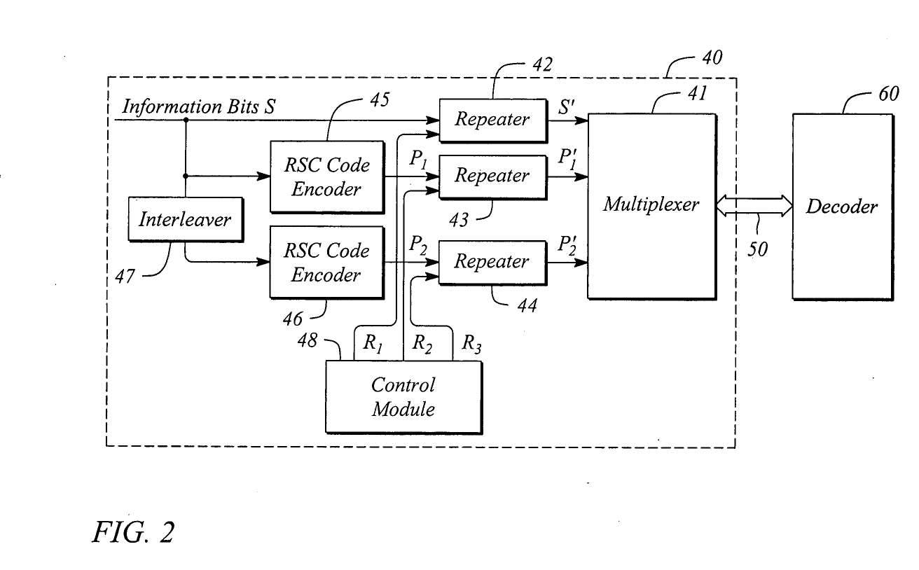

FIG. 2 shows a Turbo Code encoder 40 that generates an optimally-repeated Turbo Code bit stream T in accordance with one embodiment of the present invention. FIG. 2 also shows a Turbo Code decoder 60 operatively connected to receive the Turbo Code bit stream T transmitted via a communication channel 50 from the Turbo Code encoder 40.

As will be described in more detail below and in accordance with one embodiment of the present invention, the encoder 40 includes a first bit repeater 42 to repeat an incoming code stream (i.e., information bits S) into a repeated information bit stream S′. The encode 40 also includes a second bit repeater 43 to repeat a first parity bit stream (i.e., parity bits) P₁ of the incoming code stream into a repeated first parity bit stream P₁′. The encoder 40 also includes a third bit repeater 44 to repeat a second parity bit stream (i.e., parity bits) P₂ of the incoming code stream into a repeated second parity bit stream P₂′. Each of the repeaters 42-44 has its own bit repetition rate (i.e., R₁, R₂, or R₃,) which is set by a control module 48. The control module 48 determines the bit repetition rates R₁, R₂, and R₃ in accordance with (1) the data rate (or data transmission rate) of the communication channel 50 and (2) the desired or optimized BER (i.e., Bits Error Rate) performance of the repeated output bit stream such that the output Turbo Code stream T from the encoder 40 is optimally repeated.

A multiplexer 41 is then connected to the repeaters 42-44 to combine the repeated bit streams S′, P₁′, and P₂′ together to generate the optimally-repeated Turbo Code stream T, which is then transmitted via communication channel 50 to the decoder 60 via a communication channel. This Turbo Code stream T has its data rate matched with that of communication channel 50. The Turbo Code encoder 40 in accordance with one embodiment of the present invention will be described in more detail below, also in conjunction with FIGS. 2-4.

Referring again to FIG. 2, the Turbo Code encoder 40 can be employed in any Turbo Coded communication system. For example, the Turbo Code encoder 40 can be employed in a 3^{rd} generation wireless mobile communication system developed under any framework of 3GPP. 3GPP refers to the 3rd Generation Partnership Project, details of which can be found at WWW.3GPP.ORG.

The Turbo Code encoder 40 can be implemented by software, firmware (e.g., programmable ASICS), hardware, or a combination of thereof. In one embodiment, the Turbo Code encoder 40 is implemented by software. In another embodiment, the Turbo Code encoder 40 is implemented in hardware or firmware form.

As can be seen from FIG. 2, the Turbo Code encoder 40 receives the information bit stream S and outputs the Turbo Code stream T. The information bit stream S can also be referred to as systematic bits or information bits. The information bit stream S is the input of the Turbo Code encoder 40, and thus supplies information bits to the encoder 40. The information bit stream S may take the format of S =(s¹, s², . . . , s^{M}). In one embodiment, the information bit stream S includes a number of fixed-length frames with M bits in each frame.

The encoder 40 shown in FIG. 2 schematically represents a rate 1/3 Turbo Code encoder. This means that the Turbo Code stream T has the following format. When the number of the information bit stream S to be turbo coded is M, the bit number of the Turbo Code stream T from the encoder 40 is 3□M+K, wherein K represents the tail bits. The tail bits K will not be described in more detail below because they are not related to embodiments of the present invention.

The first part of the Turbo Code stream T is the information bit stream S itself. The second part of the Turbo Code stream T includes the repeated first parity bit stream P₁′ and the third part of the Turbo Code stream T includes the repeated second parity bit stream parity bits P₂′. The generation of the Turbo Code stream T by the Turbo Code encoder 40 is described as follows.

The information bit stream S is applied to a first RSC (Recursive Systematic Convolutional) code encoder 45 to generate the first parity bits (or bit stream) P₁. The first parity bits (or bit stream) P₁ takes the format of P₁=(p1¹,p1², . . . , p1^{M}).

In addition, the information bit stream S is applied to a second RSC code encoder 46 via an interleaver 47. The interleaver 47 permutates the information bits S in a predetermined manner set by the user of the Turbo Code encoder 40. The interleaved or permutated information bits are then applied to the RSC code encoder 46 to generate the second parity bit stream P₂. The second parity bits P₂ take the format of P₂=(p2¹,p2², . . . , p2^{M}). Each of the RSC code encoders 45-46 can be implemented by any known RSC code encoder. The structure and operation of any known RSC code encoder will not be described in more detail below. The structure and operation of the interleaver 47 are known and will not be described in more detail below.

The information bit stream S, the first parity bit stream P₁, and the second parity bit stream P₂ are then applied to one of the repeaters 42-44, separately and respectively. This means that each of the repeaters 42-44 receives one of the bit streams S, P₁, and P₂. In other words, the information bit stream S is applied to the repeater 42 to generate the repeated information bit stream S′. The first parity bit stream P₁ is applied to the repeater 43 to generate the repeated first parity bit stream P₁′. The second parity bit stream P₂ is applied to the repeater 44 to generate the repeated second parity bit stream P₂′.

As can be seen from FIG. 2, each of the repeaters 42-44 receives its own individually-set repetition rate (e.g., R₁, R₂, or R₃,) from the control module 48. This individual repetition of the information bit stream S and the first and second parity bit streams P₁, and P₂ allows the Turbo Code stream T at the output of the Turbo Code encoder 40 to be optimally repeated to allow for (1) the maximized BER performance of the Turbo Code stream T while the transmission rate of the Turbo Code stream T matches the data transmission rate of the communication channel 50. This allows the encoder 40 to control the number of bits to be repeated over the information bits S and the first and second parity bits P₁, and P₂, and provides optimum allocation of repetition to the information bits and the parity bits within the Turbo Code bit stream. In other words, the repeaters 42-44, at the control of the control module 48, can adjust the repeat pattern of the Turbo Code stream T.

This means that the above described mechanism of separately repeating the information bits and the first and second parity bits (i.e., S, P₁, and P₂) in accordance with one embodiment of the present invention allows the number of bits to be repeated over the information bits, the first parity bits, and the second parity bits to be controlled. As described above, the weight distributions for parity bits stream and information bits stream are not necessarily the same. More energy shall be assigned to the bit stream that has greater contribution in error correction capabilities to improve (or avoid degradation of) the BER performance of the Turbo Code. Thus, the bits allocated to the information bits S and the first and second parity bits P₁ and P₂ for repetition need to be optimized.

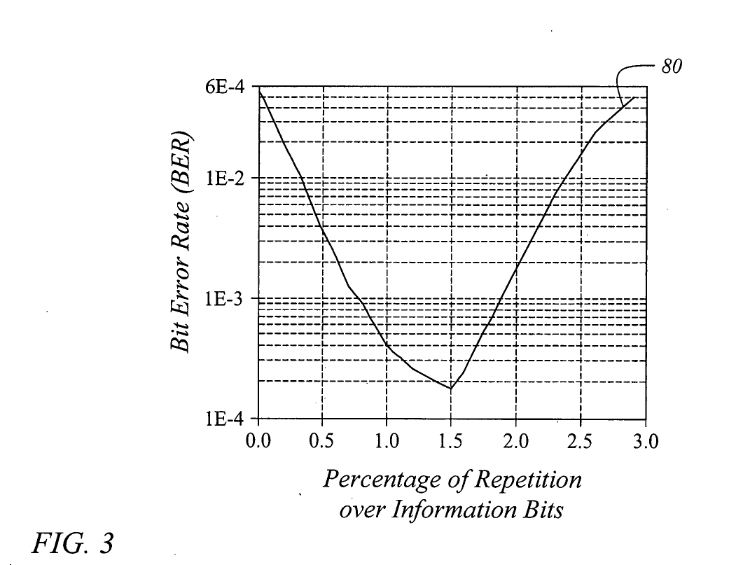

FIG. 3 shows the BER performance against the percentage of repetition allocated to information bits within a Turbo Code stream during a simulation, illustrating the need for or the result of optimum allocation of bit repetition between the information bits and parity bits. In this simulation, the interleaving length of the encoder for generating the Turbo Code for simulation is 2896 and the repetition rate is 2/3. The Eb/No is set at 1.45 db. In addition, a maximum a posteriori (MAP) type algorithm is used to decode the Turbo Code bits. The MAP algorithm is used in the turbo decoder to generate a posteriori probability estimates of the information bits that have been encoded into the code word. These probability estimates are used as a priori bit probabilities for the second MAP decoder.

As can be seen from FIG. 3, the curve 80 shows the BER value against the percentage of bit repetition allocated to the information bits S. The value in horizon axis represents the percentage of repetition allocated the information bits scaled by a factor of 3. The percentage of repetition allocated between the first and second parity bits are the same. Therefore, 0 means that all the repetition is allocated to the two parity bits and 3 indicate that all the repetition is performed over the information bits. Obviously, repetition is equally committed to the information bits, the first parity bits, and the second parity bits when the value is equal to 1.

As shown in FIG. 3, the BER curve 80 is in a “V” shape and the bottom indicates the optimum allocation of repetition to the information and parity bits, respectively. If the BER value is high, it means that the communication quality is low or poor. FIG. 3 shows that the BER performance degradation is significant when all the repetition is applied to systematic bits. This shows that excessive repetition of the information bits shall be avoided.

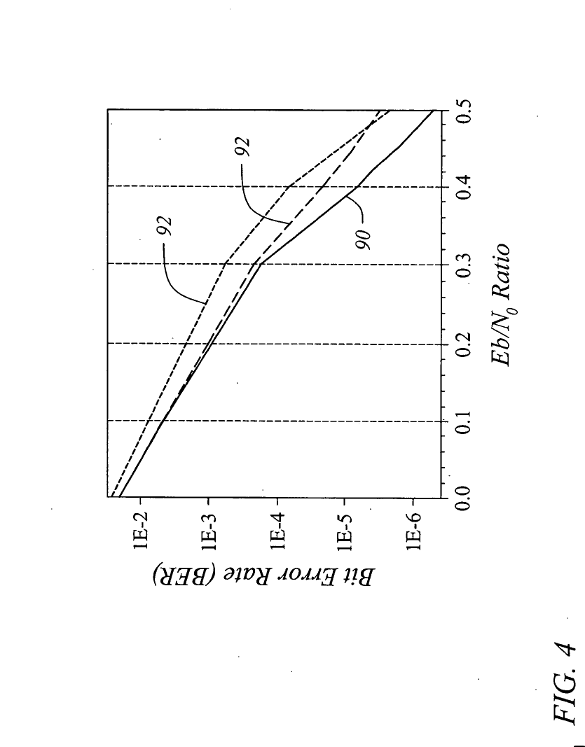

FIG. 4 further shows the BER performance improvement of a Turbo Code generated by the Turbo Code encoder of FIG. 2. FIG. 4 shows the BER value against the Eb/No value. FIG. 4 shows three cases. The curve 90 represents the case in which only the first and second parity bits are repeated. The curve 92 represents the situation in which only the information bits are repeated, and the curve 91 represents that both the information bits and parity bits are repeated using the rate match algorithm with repetition defined in 3GPP technical specification 25.212 (version 3.b.0). In this simulation, the interleaving length is 3856 and the repetition rate is 0.073.

As can be seen from FIG. 4, the curve 90 represents the best BER performance and the curve 92 represents the worst BER performance among the three situations. The curve 91, however, does not give the best result.

Referring back to FIG. 2, the above-described mechanism allows the optimum allocation of repetition to the information and parity bits for turbo coded bits stream. This also avoids any significant BER performance degradation of the Turbo Code T caused by excessive repetition of the information bits S. In addition, the repeated bits are uniformly distributed if the information bits, the first parity bits, and second parity bits are considered separately.

The multiplexer 41 receives the repeated information bit stream S′, the repeated first parity bit stream P¹′, and the repeated second parity bit stream P₂′ to generate the output Turbo Code stream T. The Turbo Code stream T is a single bit serial bit stream which is then sent to the decoder 60 via a communication channel. This means that the multiplexer 41 serialize the three code streams S, P₁, and P₂ to form the Turbo Code stream T. The multiplexer 41 can be implemented using any known multiplexing technology.

The control module 48 determines the bit repetition rates R₁, R₂, and R₃ in accordance with (1) the data rate (or data transmission rate) of the communication channel 60 and (2) the desired or optimized BER (i.e., Bits Error Rate) performance of the repeated output bit stream such that the output Turbo Code stream T from the encoder 40 is optimally repeated. The control module 48 can be implemented using any known means.

The control module 48 determines each of the bit repetition rates R₁, R₂, and R₃ in the following manner. First, let's assume that the frame length of each frame of the Turbo Code stream T is X and the length of each of the information bit stream S and the first and second parity bit streams P₁, and P₂ is of the equal length, which is X/3. The control module 48 then determines the total number of bits to be repeated (i.e., N) for the Turbo Code stream T. As described above, the total number of bits to be repeated N depends on the data transmission rate or speed of the communication channel 50.

Once the total number of bits to be repeated N is determined, the control module 48 then determines the number of the information bits and the number of the first and second parity bits to be repeated based on the allocation that produces the best BER performance. The control module 48 finds the best allocation among the three bit streams so that the best BER performance is obtained for the Turbo Code S.

Under the control of the respective one of the repetition rates R₁, R₂, and R₃, each of the repeaters 42-44 obtains the repetition bits within each of the information bit stream S and the first and second parity bit streams P₁ and P₂ and then distribute the repetition bits within the respective bit stream.

Many known methods can be used to distribute the repetition bits. In one embodiment, the rate match algorithm with repetition defined in the 3GPP technical specification 25.212 (version 3.b.0) is be used to uniformly distribute the repetition bits. In an alternatively embodiment, the repetition can be done as follows. First, start the first repetition from an arbitrary position. Then place the remaining repetition bits to over the remaining bit stream. The repetition bits shall be in equal interval. The above description is presented using rate 1/3 Turbo Code as an example. The same principle can be applied to any rate 1/N (N>3) Turbo Codes.

In the foregoing specification, the invention has been described with reference to specific embodiments thereof. The specification and drawings are, accordingly, to be regarded in an illustrative rather than a restrictive sense.

1. An apparatus of generating an output code stream, comprising:
a first bit repeater to repeat an incoming code stream;
a second bit repeater to repeat a first parity bit stream of the incoming code stream;
a third bit repeater to repeat a second parity bit stream of the incoming code stream;
a multiplexer coupled to the first, second, and third bit repeaters to combine the repeated incoming code stream, the repeated first parity bit stream, and the repeated second parity bit stream to generate the output code stream that is optimally-repeated from the incoming code stream and its parity bit streams.

2. The apparatus of claim 1, further comprising
a first parity generator to generate the first parity bit stream;
an interleaving module to interleave the incoming code stream;
a second parity generator coupled to the interleaving module to generate the second parity bit stream based on the interleaved incoming code stream.

3. The apparatus of claim 2, wherein each of the first and second parity generator is a recursive systematic convolutional code encoder.

4. The apparatus of claim 1, further comprising a control module coupled to the first, second, and third repeaters to provide each of the repeaters with an individually set repeating rate.

5. The apparatus of claim 4, wherein the repeating rate of each of the repeaters is set by the control module such that the transmission rate of the output code stream matches a transmission rate of a communication channel that transmits the output code stream to a decoder while the output code stream is optimally-repeated.

6. A method of generating an optimally-repeated output code from an incoming code, comprising
repeating the incoming code, a first parity bit stream of the incoming code, and a second parity bit stream of the incoming code individually and separately from each other such that optimal performance is obtained when the repeated incoming code, the repeated first parity bit stream, and the repeated second parity bit stream are combined to generate the output code;
combining the repeated incoming code, the repeated first parity bit stream, and the repeated second parity bit stream to generate the output code.

7. The method of claim 6, further comprising
generating the first parity bit stream by a first recursive convolutional code encoder;
interleaving the incoming code; and
generating the second parity bit stream from the interleaved incoming code by a second recursive convolutional code encoder.

8. The method of claim 6, further comprising
determining the repeating rate for each of the incoming code, the first parity bit stream, and the second parity bit stream individually and separately such that the transmission rate of the output code stream matches a transmission rate of a communication channel that transmits the output code stream to a decoder while the output code stream is optimally-repeated.
